(19) United States
(12) Patent Application Publication
(10) Pub. No.: US 2008/0007068 A1
(43) Pub. Date: Jan. 10, 2008

(54) Spherical wind turbine for generating electricity

(76) Inventor: Rogers Ward, Sacramento, CA (US)

Correspondence Address: ROGERS WARD, P.O. BOX 38895, Sacramento, CA, 95838, US

(21) Appl. No.: 11/601,717

(22) Filed: Nov. 20, 2006

Related U.S. Application Data
(60) Provisional application No. 60/819,802, filed on Jul. 10, 2006.

(51) Int. Cl. F03D 9/00; H02P 9/04

(52) U.S. Cl. 290/55

(57) ABSTRACT

An apparatus for generating electric power from wind comprised of a spherical wind turbine which powers and rotates a rotating generator to produce the desired amount of electrical current. The two portions are connected by a turbine rod which centers both instruments. The spherical designs allows for any direction of the wind and it's associated elements (rain, snow, hail, tornado, hurricane) to also act as a powering agent by increasing torque and speed of the rotation. Step up gears are optional along-with a voltage regulator to add consistency in electrical output. This apparatus is designed to be a backup or secondary source of power especially useful during inclement weather.

### CROSS REFERENCE TO RELATED APPLICATIONS

This application claims priority of U.S. Provisional application No. 60/819,802 filed Jul. 10, 2006. This is a marked up copy. This specification claims no new matter.

### FEDERALLY SPONSORED RESEARCH

N/A

### SEQUENCE LISTING OR PROGRAM

N/A

### FIELD OF INVENTION

Throughout the history of humankind, there have been many attempts to convert wind energy into other forms of energy, including for example, mechanical energy and electrical energy. Converting wind energy has had many focuses, including both the method of capture and method of conversion.

### PRIOR ART

U.S. Pat. No. 5,038,049, a Vertical Axis Wind Powered Generator, issued Aug. 6, 1991 to Shuichi Kato, teaches an apparatus for generating electric power from wind, including a base, a pair of upstanding, generally parallel spaced apart walls rotatably mounted on the base and defining an inlet in and outlet out for wind, an electric power generator mounted on the base and having an input shaft, and a vertical axis cylindrical rotor having a plurality of wind driven vanes mounted on the base between the walls, and having an output shaft coupled to rotate the input shafts.

U.S. Pat. No. 4,609,827, a synchro-Vane Vertical Axis Wind Powered Generator, Issued Sep. 2, 1986 to Richard Nepple, teaches an apparatus with airfoil shaped Vanes, a positive and synchronous vane orientation system which is controlled by a mechanism located external to its rotor.

U.S. Pat. No. 4,350,900, a Wind Energy issued Sep. 21, 1982 to Harold E. Baughman, teaches a rotary machine driven by wind including a housing with a semi-cylindrical back wall and horizontal top and bottom walls. A plurality of intake ducts open across the front of the housing to direct the flow against a plurality of vertical vanes carried on and around a cylindrical rotor within the housing.

U.S. Pat. No. 4,551,631, a Wind and Solar Electric Generating Plant, issued Nov. 5, 1985 to Gaetano T. Trigilio, teaches a plurality of turbine assemblies rotating on a common axis traverse of a base.

### BRIEF SUMMARY OF THE INVENTION

The present invention is a clear improvement over the prior cited art as it does not require special means to focus the wind energy. The present invention consists of an apparatus with several components. The principal component is made from a lightweight metal in a spherical shape with a plurality of solid wind vanes attached to a central hollow cylinder and radiating outwards. The hollow cylinder has a cap on both the top and the bottom with holes in the raised centers of the caps to support a turbine rod that passes through the top and the bottom of the cylinder caps.

The turbine rod is loose fitting in the center of both the top and the bottom hollow cylinder caps to allow free rotation of the spherical wind turbine that is attached to the turbine rod by stabilizer rods.

The lower extension of the turbine rod is attached to brushes that rotate with the turbine rod inside a generator. The current produced by the rotation of the spherical wind turbine and its attached turbine rod in the generator/alternator is then funneled through a voltage regulator to insure consistency in electrical output. The design of the apparatus is to allow the power of the wind from any direction to rotate the turbine rod inside the alternator/generator.

Increasing the number of solid wind vanes comprising the spherical wind turbine results in greater speed of rotation and torque of the turbine rod inside the generator/alternator, resulting in greater electrical output. The spherical wind turbine is designed to capture wind from any direction. It is expected that the present invention will be used as a primary, secondary auxiliary or emergency source of power in conjunction with centralized electrical sources.

### BRIEF DESCRIPTION OF THE DRAWINGS/PREFERRED EMBODIMENT

### Figures

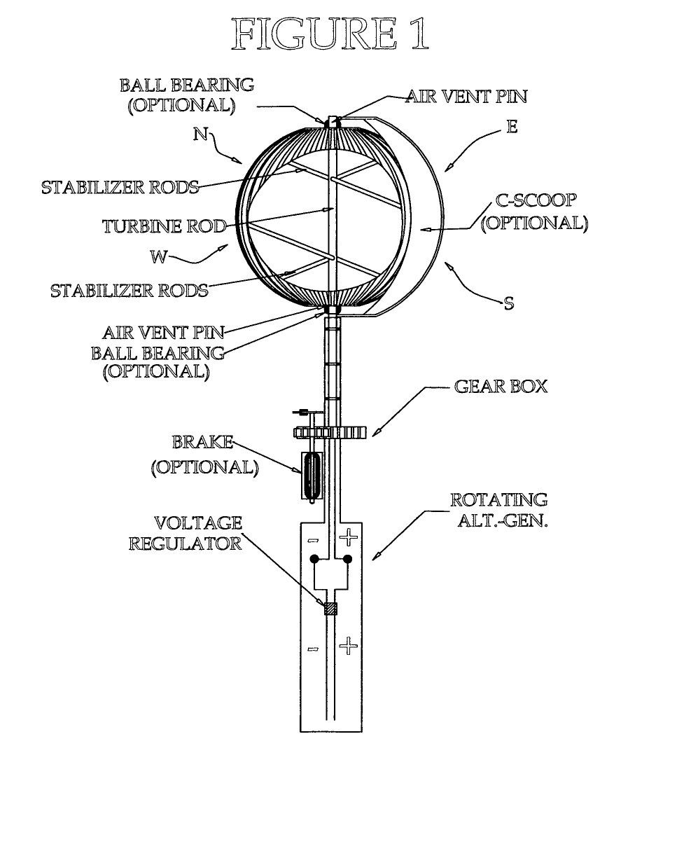

FIG. 1 depicts an up-close of the major components of the invention

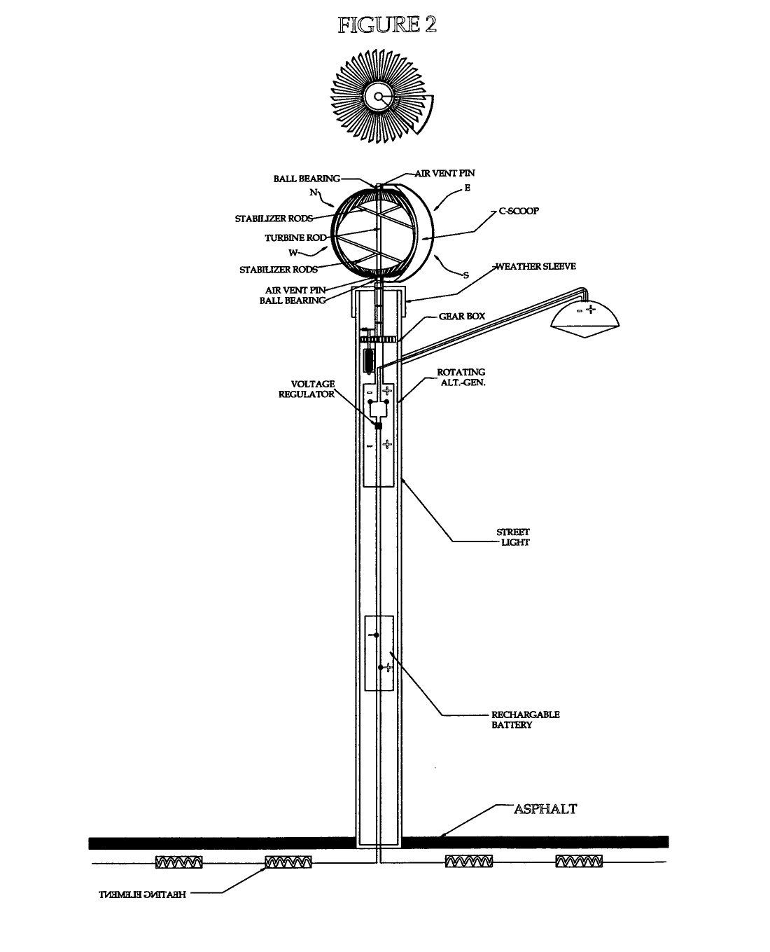

FIG. 2 depicts an embodiment of the invention incorporated into a street light pole

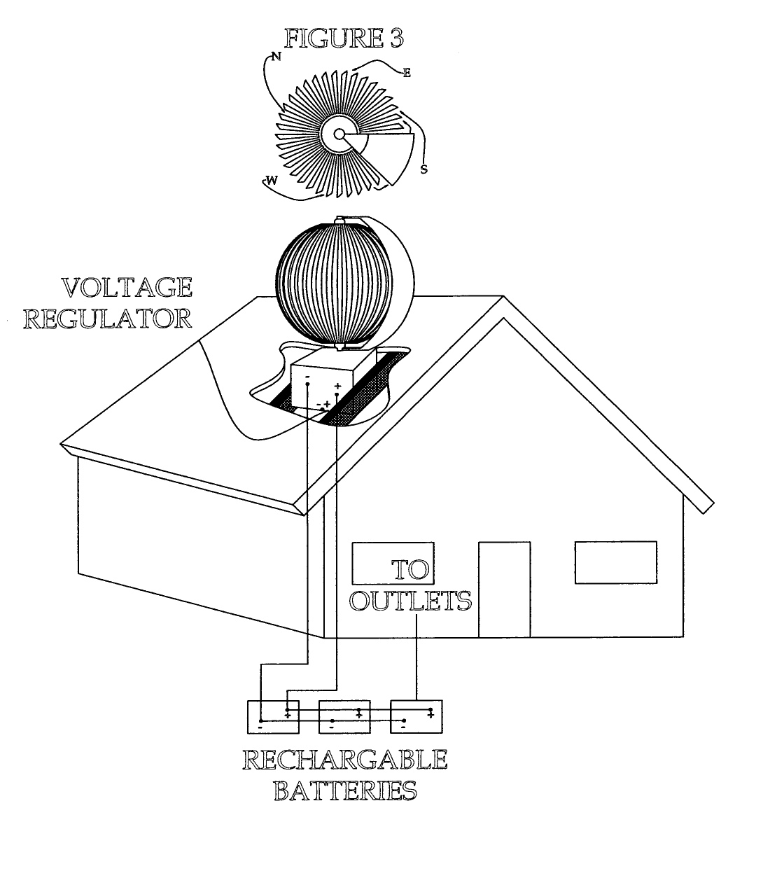

FIG. 3 depicts an embodiment of the invention mounted to the roof of a house.

1. A self-contained apparatus for creating electrical energy from wind comprising:
A spherical turbine made of light-weight metal, with indentions or grooves to capture the movement of the wind from any direction. The grooves are inward from the exterior and outward from the interior turbine rod.
The grooves or external turbine blades are attached centrally by a turbine rod.
The turbine rod is attached to the internal rotors or brushes inside a standard rotating alternator/generator.
Dependent claim:
a. The design of combining grooves and solid surface is specifically designed to utilize any and all associated elements of the wind including, rain, snow, sleet hail, wind gusts, thunderstorms, snowstorms, hurricanes and tornadoes to create electricity to increase speed and torque of blades and increase capability of creating electricity.
